(19) United States
(12) Patent Application Publication
(10) Pub. No.: US 2003/0084772 A1
(43) Pub. Date: May 8, 2003

(54) Cutting device of packaging machine

(76) Inventor: Ying Liang Shen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/985,365

(22) Filed: Nov. 5, 2001

(51) Int. Cl. B26D 5/08

(52) U.S. Cl. 83/597; 83/607; 83/663

(57) ABSTRACT

A cutting device is incorporated in a packaging machine having at least one expansion cylinder consisting of upper and lower sections with a gap therebetween. The cutting device includes a rotation ring concentrically surrounding and spaced from the expansion ring. The rotation ring is coupled to a driving system for concentric rotation with respect to the expansion cylinder. A number of cutting members are pivoted to the ring. Each cutting member includes a cutting blade and a weight on opposite sides of the pivot thereof. A spring is connected between the weight and the rotation ring for biasing the cutting blade to a stowed position where a sharp edge of the cutting blade is spaced from the gap. When the rotation ring is rotated at a high speed, a centrifugal force acts upon each weight thereby moving the cutting member against the spring toward a cutting position where the sharp edge of the cutting blade partially extends into the gap for cutting off a packaging material fit over the expansion cylinder.

### FIELD OF THE INVENTION

The present invention generally relates to a packaging machine for packaging an article with a tubular film, and in particular to a cutting device adapted in the packaging machine for cutting off a continuous length of the packaging material.

### BACKGROUND OF THE INVENTION

Shrinkable films made of synthetic materials have been widely used to package consumer products, such as compact disk (CD) pack. The package operation is usually done with a packaging machine. FIG. 8 of the attached drawings shows an example of a conventional packaging machine. In the conventional packaging machine, a packaging material C in a continuous, flattened tubular configuration is supplied from a roll to a feeding mechanism A. The feeding mechanism A comprises a number of expansion cylinders B which expands the tubular packaging material C and fit the expanded tube over articles E to be packaged.

As shown in FIG. 9, a cutting device D is provided in the feeding mechanism A for cutting off the continuous packaging material C to desired lengths. The conventional cutting device D comprises a number of cutting blades D1 arranged around one expansion cylinder C (not shown in FIG. 9). Such an arrangement has certain disadvantages. For example, it has a complicated mechanical structure for it needs a number of cutting blades D1 driven by a complicated belt-pulley system D2. Such a complicated structure not only increases the overall manufacturing costs but also adding unnecessary expense and shutdown time for maintenance. In addition, arranging all the blades D1 exactly in a common plane is in general very difficult. Zigzag edges may thus be formed on the packaging material C by the blades D1 that are not perfectly aligned. Moreover, the cutting efficiency is low due to such a multiple blade arrangement.

Meanwhile, additional control measures or devices D4, D5, D6 have to be employed to cooperate with a driving device D3 for precisely controlling the operation of the cutting blades D1. Costs are thus further increased. Furthermore, the large number of cutting blades D1 may cause substantial noise during operations. In addition, the movement of the cutting blades D1 approaching and away from the packaging material C is also a cause of noise, especially when the approaching and leaving speed of the cutting blades DI are not well controlled.

Further, such a complicated structure makes it very difficult to accommodate packaging materials of different sizes for one has to replace the original transmission system with a new one. Costs and shutdown time can be substantially increased.

U.S. Pat. No. 5,791,220, entitled “Cutting Device of Packing Apparatus” and U.S. Pat. No. 5,531,858, entitled “Shrinkable Label Inserting Machine” disclose packaging machines having a structure similar to the above discussed techniques and of course share the above disadvantages.

It is thus desirable to provide a cutting device to be incorporated in a packaging machine for alleviating the above mentioned problems.

### SUMMARY OF THE INVENTION

Accordingly, an object of the present invention is to provide a cutting device of a packaging machine having a simple structure and thus low costs.

Another object of the present invention is to provide a cutting device comprising a number of cutting blades that can be operated substantially synchronously for cutting off a continuous packaging material thereby forming an even and neat edge on the packaging material.

Another object of the present invention is to provide a reliable and easy-to-maintain cutting device.

Another object of the present invention is to provide a cutting device wherein cutting blades are self-operable with additional, sophisticated controlling devices.

A further object of the present invention is to provide a cutting device that is easy to be removed from a packaging machine for replacement.

A further object of the present invention is to provide a cutting device capable to accommodate packaging materials of different sizes.

Yet a further object of the present invention is to provide a cutting device which operates at a low cost for cutting off packaging materials.

To achieve the above objects, in accordance with the present invention, there is provided a cutting device adapted to be incorporated in a packaging machine for cutting off a continuous supply of packaging material through an expansion cylinder consisting of upper and lower sections with a gap therebetween. The cutting device comprises a rotation ring concentrically surrounding and spaced from the expansion ring. The rotation ring is coupled to a driving system for concentric rotation with respect to the expansion cylinder. A number of cutting members are pivoted to the ring. Each cutting member comprises a cutting blade and a weight on opposite sides of the pivot thereof. A spring is connected between the weight and the rotation ring for biasing the cutting blade to a stowed position where a sharp edge of the cutting blade is spaced from the gap. When the rotation ring is rotated at a high speed, a centrifugal force acts upon each weight thereby moving the cutting member against the spring toward a cutting position where the sharp edge of the cutting blade partially extends into the gap for cutting off a packaging material fit over the expansion cylinder.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a cutting device adapted in a packaging machine and constructed in accordance with a first embodiment the present invention;

FIG. 2 is a side elevational view of FIG. 1;

FIG. 3 is top plan view of the cutting device of the present invention, cutting blades of the cutting device being att a stowed position;

FIG. 4 is similar to FIG. 3 but showing the cutting blades at a cutting position;

FIG. 5 is a side elevational view showing a cutting device in accordance with a second embodiment of the present invention;

FIG. 6 is a top plan view showing a cutting device in accordance with a third embodiment of the present invention;

FIG. 7 is a side elevational view showing a cutting device in accordance with a fourth embodiment of the present invention;

FIG. 8 is a perspective view of a conventional packaging machine in which the cutting device of the present invention may be adapted to replace a conventional cutting device thereof; and

FIG. 9 is a perspective view showing the conventional cutting device adapted in the packaging machine illustrated in FIG. 8.

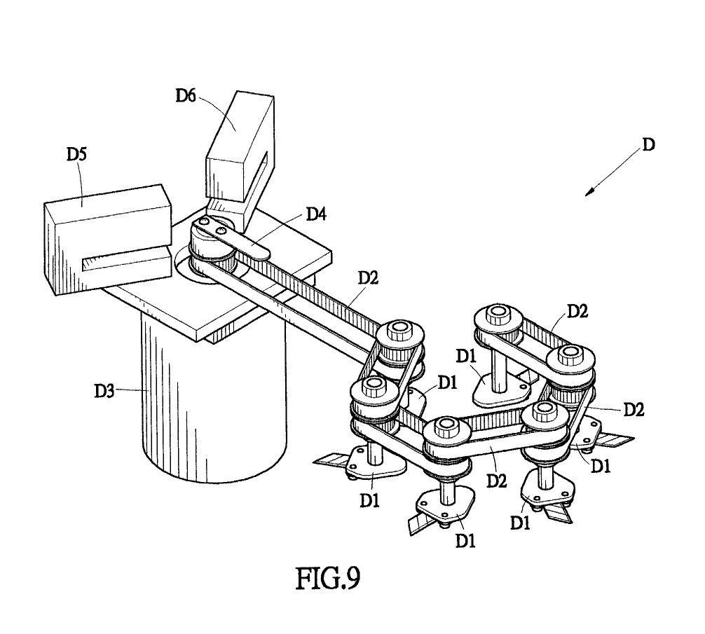

### DETAILED DESCRIPTION OF THE PREFERRED EMBODIMENTS

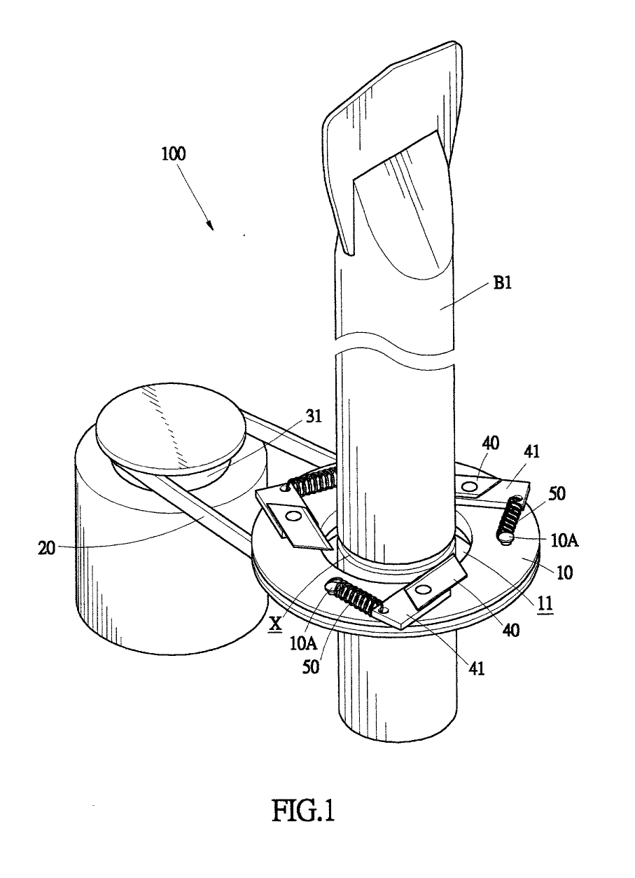

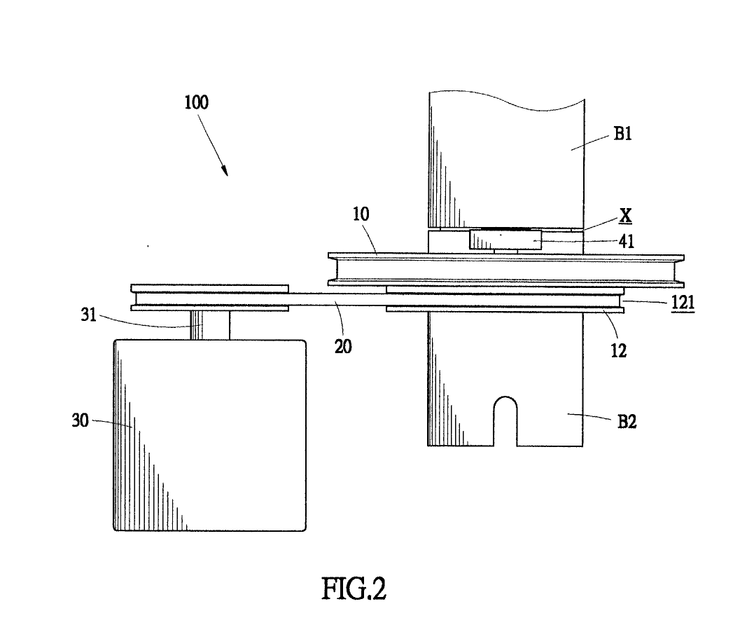

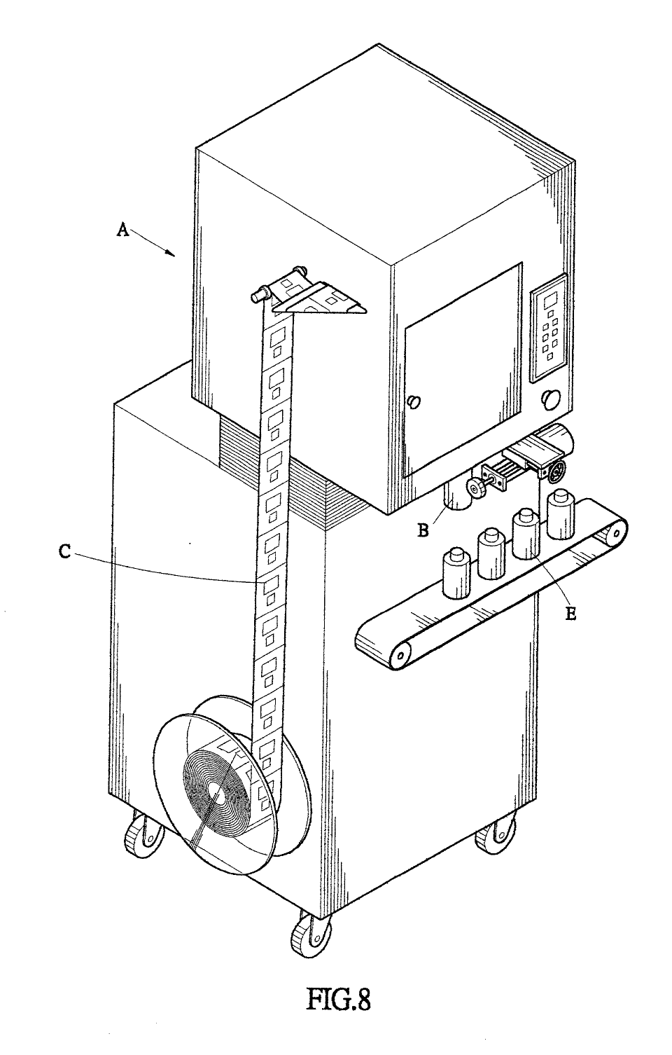

With reference to the drawings and in particular to FIGS. 1 and 2, a cutting device constructed in accordance with a first embodiment of the present invention, generally designated with reference numeral 100, comprises a rotatable ring 10 defining a central bore 11 through which an expansion cylinder B of a packaging machine A (see FIG. 8) extends whereby the rotatable ring 10 concentrically surrounds and is spaced from the expansion cylinder B. In the embodiment illustrated, the expansion cylinder B consists of an upper cylindrical section B1 and a lower cylindrical section B2 co-axially aligned with each other with a gap X formed between confronting ends of the upper and lower sections B1, B2. A plurality of driving rollers B3, B4 are arranged beside the upper and lower sections B1, B2 of the expansion cylinder B for driving a tubular like packaging material C in a downward direction, as viewed in the drawing of FIG. 1.

The ring 10 has a top side face (not labeled) on which a plurality of projections 10A are formed and an opposite bottom side face on which an annular driving member 12 is concentrically formed. The annular driving member 12 can be integrally formed with the ring 10. Alternatively, the annular driving member 12 is secured to the ring 10 with suitable fasteners. The driving member 12 has a cylindrical outside surface (not labeled) on which a circumferential groove 121 is formed whereby the driving member 12 functions as a pulley with which a belt 20 engages. The belt 20 also engages with an output spindle 31 of a driving device or a torque source 30, such as an electrical motor. Actuating the motor 30 drives the ring 10 to rotate with respect to the expansion cylinder B.

Although it is not shown in the drawings, it is apparent to those having ordinary skills of mechanics to rotatably support the ring 10, as well as the driving member 12, with a suitable mount (not shown).

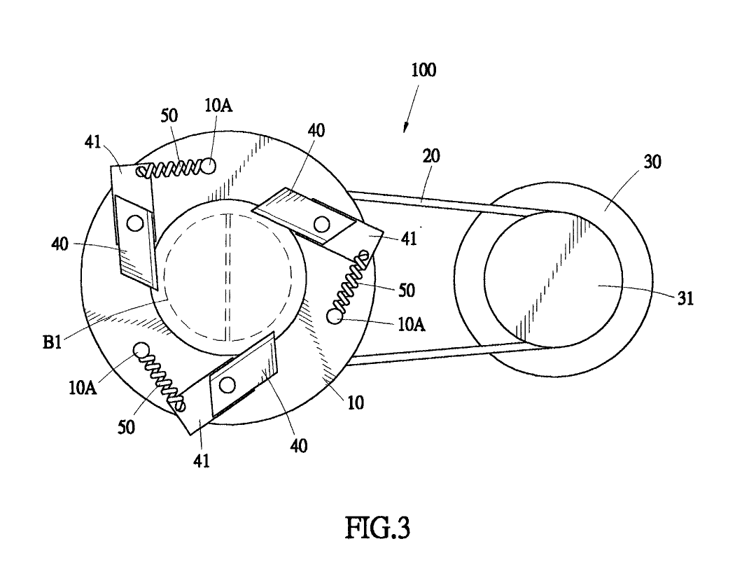

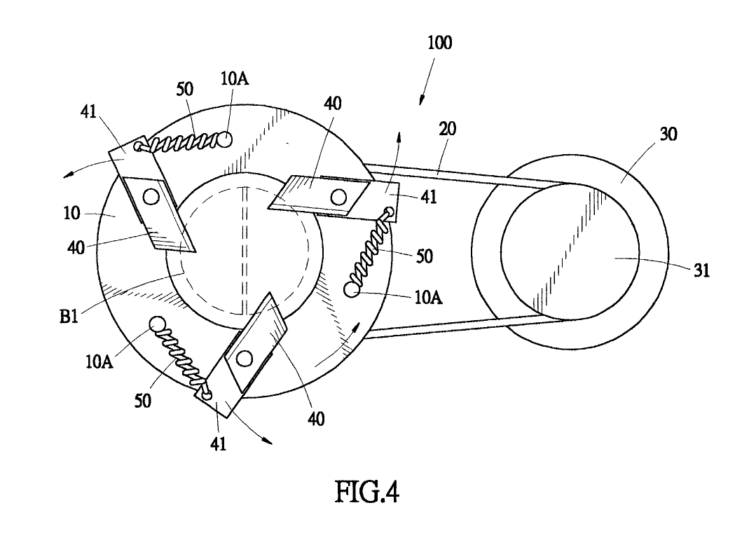

A plurality of cutting blades 40 are movably mounted on the top side face of the ring 10 and each corresponds to one of the projections 10A. Each cutting blade 40 has a sharp edge (not labeled) confronting and substantially aligned with the gap X of the expansion cylinder B. In the embodiment illustrated, the cutting blades 40 are pivoted to the top side face of the ring 10 whereby the cutting blades 40 is movable between an inner, cutting position (FIG. 4) where the sharp edges of the cutting blades 40 partially extend into the gap X for cutting off the packaging material C along a circumference of the gap X and an outer, stowed position (FIG. 3) where the cutting blades 40 are spaced from the gap X. A weight 41 is mounted to each cutting blade 40 in such a way that the weight 41 and the cutting blade 40 are substantially on opposite sides of the pivot of the cutting blade 40. A biasing element 50, such as a helical spring, is connected between each weight 41 and the corresponding projection 10A for biasing the cutting blade 40 toward the outer position.

Also referring to FIGS. 3 and 4, when the ring 10 is rotated at a slow or zero speed, the biasing elements 50 force the cutting blades 40 toward the outer position as shown in FIG. 4. When the ring 10 is rotated at a high speed, a centrifugal force acts upon each weight 41 against the biasing force of the corresponding biasing element 50, thereby driving the weight 41 in such an outward direction (indicated by arrows of FIG. 4) which causes the sharp edge of the corresponding cutting blade 40 toward the inner position and thus cutting off the packaging material C. All the cutting blades 40 are actuated at substantially at the same time if all the weights 41 are substantially the same. This provides a neat and effective cutting operation of the packaging material C.

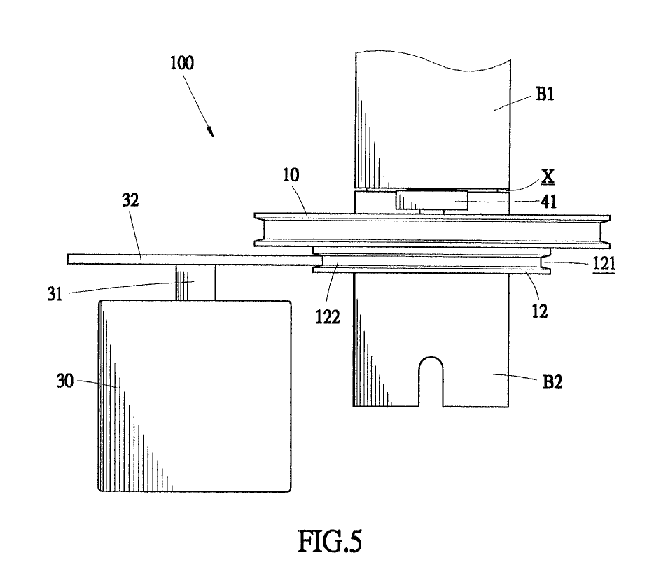

FIG. 5 shows a cutting device in accordance with a second embodiment of the present invention. The cutting device of the second embodiment is also designated with reference numeral 100 for simplicity. A wheel 32 is mounted to the output spindle 31 of the motor 30. The wheel 32 has a circumferential edge partially received in the groove 121 of the driving member 12 for tangentially and physically engaging a bottom of the groove 121 whereby a mechanical coupling between the motor 30 and the ring 10 is established. If desired, the wheel 32 may be so sized that opposite faces thereof engage side walls of the groove 121 for enhancing the coupling therebetween. Preferably, a layer of high frictional coefficient material 122 is formed on the bottom of the groove 121. A rubber ring fit over the groove 121 is an example. In this respect, the wheel 32, at least the circumferential edge thereof, is preferably made of a material that has a significant friction with the layer 122 of the groove 121 for enhancing a driving coupling therebetween.

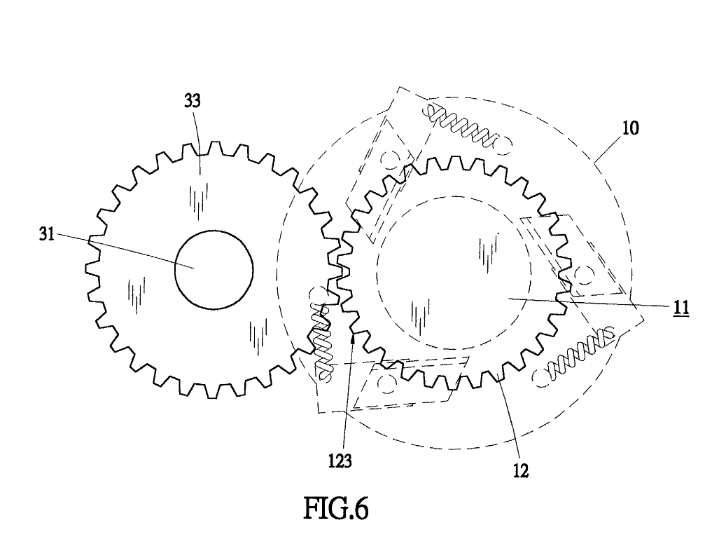

FIG. 6 shows a cutting device in accordance with a third embodiment of the present invention wherein the driving member 12 is formed with a toothed edge 123 for mating with a pinion 33 mounted to the output spindle 31 of the motor 30. The toothed engagement between the driving member 12 and the pinion 33 provides the driving coupling between the motor 30 and the ring 10.

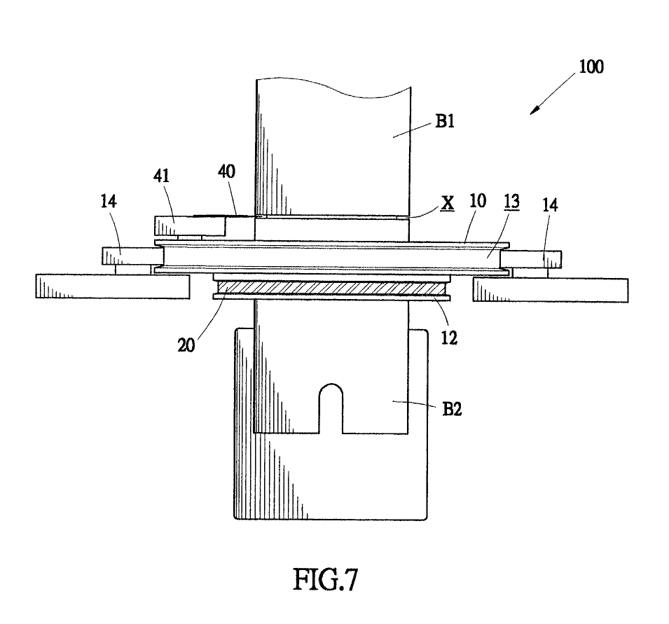

FIG. 7 shows a cutting device in accordance with a fourth embodiment of the present invention, which is similar to the first embodiment illustrated with reference to FIGS. 1-4 and is also designated with reference numeral 100 for simplicity. Elements or parts of the fourth embodiment cutting device that are identical or similar to those of the first embodiment cutting device are designated with the same reference numerals and the discussion thereof will be omitted for simplicity. In the fourth embodiment, the ring 10 of the cutting device 100 has a cylindrical outer surface in which a circumferential race 13 is defined for guidingly receiving guide rollers 14 that are rotatably supported in the cutting device 100. The guide rollers 14 that are received in the race 13 function to maintain a stable rotation of the ring 10, eliminating undesired vibration or axial shift of the ring 10 during operation.

It can be seen from the above description of the preferred embodiments of the present invention that the invention provides a cutting device of simple structure of which the maintenance and repairing can be readily done. In addition, the present invention allows users to readily replace the ring 10 (including the cutting blades 40 mounted thereon) with one of different size for accommodating packaging materials of different size. The adaptability of the cutting device of the present invention is thus enhanced. Further, the cutting blades 40 are controlled by centrifugal forces caused by the rotation of the ring 10. No additional, sophisticated controlling device is required. Costs of manufacturing can thus be substantially reduced.

Although the present invention has been described with reference to the preferred embodiments thereof, it is apparent to those skilled in the art that a variety of modifications and changes may be made without departing from the scope of the present invention which is intended to be defined by the appended claims.

What is claimed is

1. A cutting device adapted to be incorporated in a packaging machine having an expansion cylinder consisting of upper and lower sections with a gap therebetween, the cutting device comprising:
a rotation ring concentrically surrounding the expansion cylinder and spaced therefrom, the rotation ring being rotatable with respect to the expansion cylinder;
a driving system selectively rotating the rotation ring with respect to the expansion cylinder; and
at least one cutting member pivoted to a top surface of the rotation ring, the cutting member comprising, on opposite sides of the pivot thereof, a blade having a sharp edge substantially corresponding to the gap and a weight, a biasing element connected to the cutting member and biasing the sharp edge toward a stowed position where the sharp edge of the blade is spaced from the gap, wherein when the rotation ring is driven by the driving system to rotate, a centrifugal force acting upon the weight moves the sharp edge of the blade against the biasing element toward a cutting position where the sharp edge partially extends into the gap for cutting off a packaging material fit over the expansion cylinder along the gap.

2. The cutting device as claimed in claim 1, wherein the biasing element comprises a helical spring having a first end attached to the weight and a second end attached to a projection formed on the top surface of the rotation ring.

3. The cutting device as claimed in claim 1, wherein the driving system comprises a pulley formed on the rotation ring and a belt coupling the pulley to a torque source.

4. The cutting device as claimed in claim 1, wherein the rotation ring comprises a circumferential surface on which a layer of a high frictional coefficient material is attached, the driving system comprising a circular member driven by a torque source and having a portion of high frictional coefficient drivingly engaging the circumferential surface.

5. The cutting device as claimed in claim 1, wherein the rotation ring comprises teeth formed along a circumference, the driving system comprising a toothed wheel driven by a torque source and drivingly mating the teeth of the ring.

6. The cutting device as claimed in claim 1, wherein the rotation ring defines a circumferential race in which a guide roller is matingly received for supporting a stable rotation of the rotation ring.
